(19) United States
(12) Patent Application Publication
(10) Pub. No.: US 2024/0234972 A1
(43) Pub. Date: Jul. 11, 2024

(54) BATTERY MODULE AND METHOD OF ASSEMBLING SAME

(71) Applicant: SK On Co., Ltd., Seoul (KR)

(72) Inventor: Hyun Seok KIM, Daejeon (KR)

(21) Appl. No.: 18/467,732

(22) Filed: Sep. 15, 2023

(30) Foreign Application Priority Data
Jan. 10, 2023 (KR) 10-2023-0003608

(51) Int. Cl. H01M 50/533; H01M 50/211; H01M 50/505; H01M 50/516

(52) U.S. Cl. CPC H01M 50/533; H01M 50/211; H01M 50/505; H01M 50/516

(57) ABSTRACT

Proposed are a battery module and a method of assembling the battery module. The battery module includes a plurality of battery cells each including an electrode tab; and a busbar having a plurality of slits, and electrically connecting the plurality of battery cells to each other, wherein the electrode tab is bent and is inserted into the slit, and wherein a bent portion of the electrode tab inserted into the slit and the busbar are joined to each other by a welded portion. The present disclosure may include a method of assembling a battery module using a bent electrode tab and a slit of a busbar.

### CROSS REFERENCE TO RELATED APPLICATION

The present application claims priority to Korean Patent Application No. 10-2023-0003608, filed Jan. 10, 2023, the entire contents of which is incorporated herein for all purposes by this reference.

### BACKGROUND

### 1. Technical Field

The present disclosure relates to a battery module and, more particularly, to a battery module in which a junction structure between an electrode tab and a busbar is improved. In addition, the present disclosure includes an assembly method that ensures a reliable electrical connection between an electrode tab and a busbar in a battery module.

### 2. Related Art

A secondary battery can be repeatedly charged and discharged, and can be applied to various fields such as mobile devices, electric vehicles (EV), hybrid electric vehicles (HEV) and energy storage systems (ESS). With the continuous development of technology, a model which is more compact and is capable of outputting powerful power is being developed.

Typically, a secondary battery is composed of an electrode assembly, a pouch case which accommodates the electrode assembly, and an electrode tab which extends from the electrode assembly and protrudes to the outside. A plurality of secondary batteries is connected together in series and/or in parallel to be used in an electric vehicle or a hybrid electric vehicle with a high output. The plurality of secondary batteries is fixed using a member such as a cover or a case, and is electrically connected with each other by a busbar or the like to be used in a single battery module type.

As mentioned above, the busbar is joined to electrode tabs to electrically connect battery cells. In order for stable junction between the electrode tab of the battery cell and the busbar, in a conventional battery module, as illustrated in FIG. 1, an electrode tab 111 which has passed through a slit 121 is bent to be brought into contact with a busbar 120, and then, one end of the electrode tab 111 which is bent and the busbar 120 are welded together while being brought into close contact with each other, to be contact-fixed to each other. Such a conventional battery module cannot help but be disadvantageous in terms of welding efficiency since a space for disposing a welding jig for bringing the electrode tab in a bent shape and the busbar into close contact with each other should be secured.

In particular, in order to increase energy density, that is, volumetric energy density (energy per unit volume of a battery), battery cells tend to be made thinner and thinner. According to this trend, a junction area between the electrode tab and the busbar is also reduced so that coupling strength may decrease, and a problem is caused in that the electrode tabs may be connected with each other during a welding operation.

### SUMMARY

The present disclosure provides a battery module in which a junction structure between an electrode tab and a busbar is improved.

In addition, the present disclosure includes an assembly method capable of contact-fixing an electrode tab and a busbar to be electrically connectable to each other by a welding method, specifically, a laser welding method.

According to a first aspect of the present disclosure, a battery module may include: a plurality of battery cells each including an electrode tab; and a busbar having a plurality of slits, and electrically connecting the plurality of battery cells together, wherein the electrode tab is bent and is inserted into the slit, and wherein a bent portion of the electrode tab inserted into the slit and the busbar are joined to each other by a welded portion.

According to an embodiment, the bent portion of the electrode tab may be inserted to protrude by passing through the slit.

According to an embodiment, the electrode tab may be bent at a bending angle set in a range of greater than 90° and no greater than 180°.

According to an embodiment, the electrode tab may include: an extension portion protruding outward from an electrode assembly of the battery cell; a distal end-side extension portion bent at a predetermined bending angle with respect to an extension line of the extension portion; and a bending portion integrally connecting the extension portion and the distal end-side extension portion to each other.

According to an embodiment, the electrode tab may be formed with a bending groove on one surface of the bending portion.

According to an embodiment, the welded portion may be formed by laser welding.

According to a second aspect of the present disclosure, a method of assembling a battery module may include: bending an electrode tab of a battery cell at a predetermined bending angle; inserting and disposing a bent portion of the electrode tab into a slit of a busbar; and welding the bent portion of the electrode tab and the busbar to electrically connect the electrode tab and the busbar to each other, wherein the bending angle of the electrode tab is set in a range of greater than 90° and no greater than 180°.

According to an embodiment, the electrode tab may include: an extension portion protruding outward from an electrode assembly of the battery cell; a distal end-side extension portion bent at a predetermined bending angle with respect to an extension line of the extension portion; and a bending portion integrally connecting the extension portion and the distal end-side extension portion to each other.

According to an embodiment, in the inserting and disposing of the bent portion of the electrode tab into the slit of the busbar, the bent portion of the electrode tab may be inserted to protrude by passing through the slit.

According to an embodiment, the bent portion of the electrode tab may protrude by a predetermined protruding length P from an outer surface of the busbar, where 0.3 mm≤P≤2.0 mm.

According to an embodiment, in the inserting and disposing of the bent portion of the electrode tab into the slit of the busbar, a gap may be provided between the bent portion of the electrode tab and the slit of the busbar.

Features and advantages of the present disclosure will be more apparent from the following detailed description taken in conjunction with the accompanying drawings.

Prior to the following detailed description, the terms or words used in the specification and the claims of the present disclosure should not be construed as being typical or dictionary meanings, but should be construed as meanings and concepts conforming to the technical spirit of the present disclosure on the basis of the principle that an inventor can properly define the concepts of the terms in order to describe his or her invention in the best way.

According to the embodiments of the present disclosure, it is possible to ensure a reliable electrical connection between an electrode tab of a battery cell and a busbar.

In particular, the present disclosure may simplify a junction process with a busbar by means of a bent electrode tab without using facilities such as a welding jig.

### BRIEF DESCRIPTION OF THE DRAWINGS

FIG. 1 is a view schematically illustrating a battery module according to the conventional art, showing a coupled state between electrode tabs and a busbar.

FIG. 2 is a view schematically illustrating a battery module according to the present disclosure.

FIG. 3 is an exploded perspective view illustrating a state before electrode tabs of battery cells and a busbar are coupled.

FIG. 4 is a cross-sectional view of an elliptical portion indicated in FIG. 2, illustrating a coupled state between the electrode tab and the busbar.

FIG. 4A is a cross-sectional view illustrating a coupled state between the electrode tab bent at a different bending angle and the busbar.

FIGS. 5A to 5C are views schematically illustrating a battery cell to which an electrode tab of another embodiment is applied, wherein FIG. 5A is a side view showing a state before the electrode tab is bent, FIG. 5B is a side view showing a state in which the electrode tab is completely bent at 180° and FIG. 5C is a side view showing a state in which the electrode tab is completely bent into a V shape.

FIGS. 6A to 6C are schematic diagrams illustrating the steps of a method of assembling a battery module according to the present disclosure.

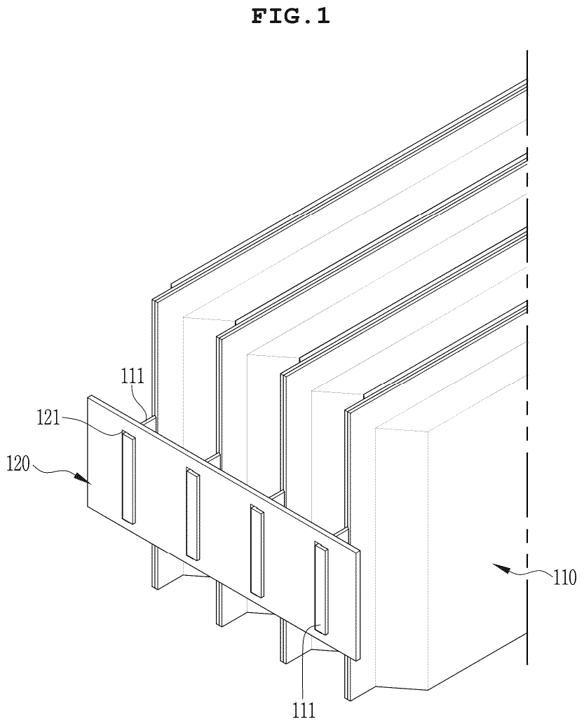

### DETAILED DESCRIPTION

The objects, advantages, and features of the present disclosure will be more apparent from the following detailed description of embodiments taken in conjunction with the accompanying drawings, but the present disclosure is not limited thereto. In describing the present disclosure, when it is determined that the detailed description of the related art may obscure the gist of the present disclosure, the detailed description will be omitted.

Embodiments described in the present document and the accompanying drawings are not intended to limit the present disclosure to specific implementations. It should be understood that the present disclosure includes various modifications, equivalents and/or alternatives of embodiments.

In the following description, the same components will be designated by the same reference numerals although they are shown in different drawings, and similar components will be designated by similar reference numerals.

In the present document, terms such as first and second are used to distinguish one component from another component, and components are not limited by the terms. In the accompanying drawings, some components are exaggerated, omitted or schematically illustrated, and the size of each component does not entirely reflect an actual size.

Hereinafter, an embodiment of the present disclosure will be described in detail with reference to the accompanying drawings.

The present disclosure relates to a battery module in which electrode tabs of battery cells arranged by being stacked and a busbar are joined to each other to be electrically connected together, and provides good welding quality between the electrode tabs and the busbar to improve the durability of the battery module. In addition, the present disclosure may increase productivity by laser welding.

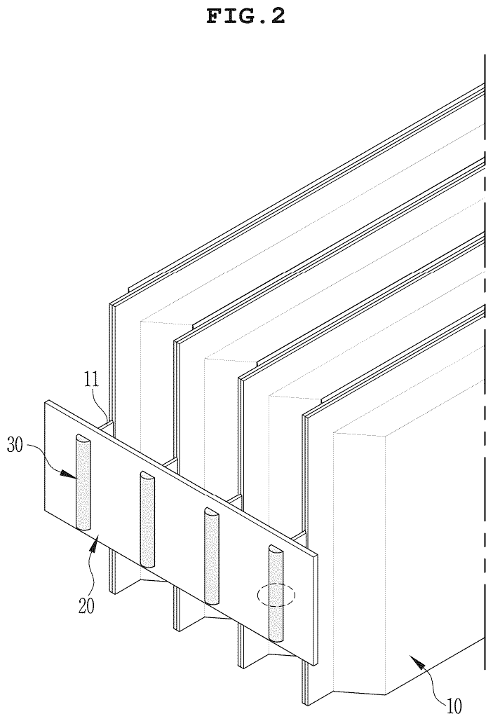

Referring to FIGS. 2 to 4, a battery module according to the present disclosure includes a plurality of battery cells 10 and a busbar 20 which electrically connects the plurality of battery cells 10 together.

In the battery module according to the present disclosure, an electrode tab 11 of the battery cell 10 and the busbar 20 may be joined by a welding method, and may be joined by laser welding to ensure a stable connection state between the electrode tab 11 and the busbar 20 and provide productivity and easiness in process management. The present disclosure is not limited to laser welding, and various welding methods capable of fixing the electrode tab 11 and the busbar 20 in contact with each other may be applied.

As shown, in the battery module, the plurality of battery cells 10 may be disposed to be stacked parallel to each other in one direction. The battery cell 10 may be a pouch-type secondary battery having a structure in which the electrode tab 11 protrudes outward.

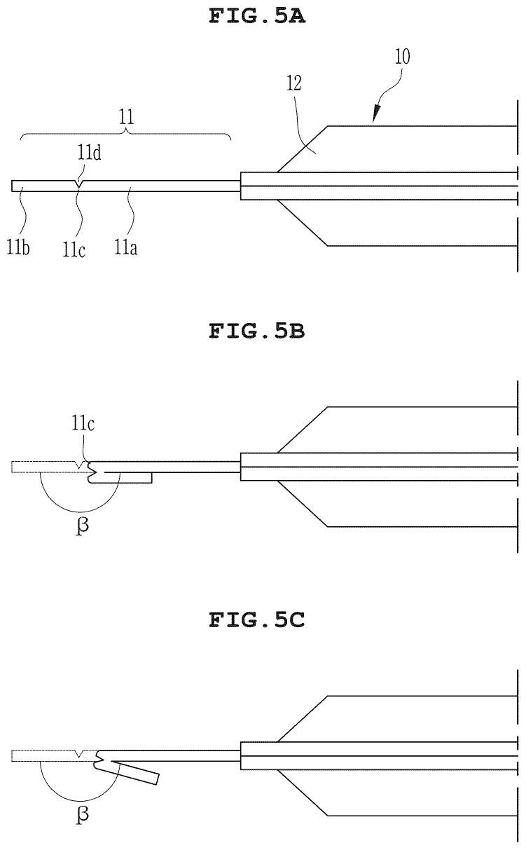

The battery cell 10 may include an electrode assembly (not shown), a pouch case 12 (see FIG. 5A) which accommodates the electrode assembly, and the electrode tab 11. The electrode tab 11 may include a positive electrode tab made of aluminum and a negative electrode tab made of copper, which electrically connect a positive electrode plate and a negative electrode plate constituting the electrode assembly to the external busbar 20.

As described above, the electrode tab 11 is coupled to the electrode plate (the positive electrode plate or the negative electrode plate) of the electrode assembly and is exposed to the outside of the pouch case 12, thereby being electrically connected to the busbar 20.

In the present disclosure, a thickness T of the electrode tab 11 has a range of 0.3 mm to 1.0 mm. For example, the electrode tab 11 made of aluminum may have a thickness range of 0.4 mm to 1.0 mm, and the electrode tab 11 made of copper may have a thickness range of 0.3 mm to 0.8 mm.

In particular, the electrode tab 11 is designed in a bending structure to be fitted into a slit 21 of the busbar 20 which will be described later and thereby be contact-fixed by welding. In detail, the electrode tab 11 is composed of an extension portion 11a, a distal end-side extension portion 11b which overlaps with the extension portion 11a, and a bending portion 11c which is interposed between the extension portion 11a and the distal end-side extension portion 11b.

As is known to those skilled in the art, the extension portion 11a may be formed in a flat shape which protrudes outward from the electrode assembly.

The distal end-side extension portion 11b may be bent at a predetermined bending angle at the bending portion 11c. A bending angle β (see FIG. 5) means the angle between the extension line of the extension portion 11a and the distal end-side extension portion 11b.

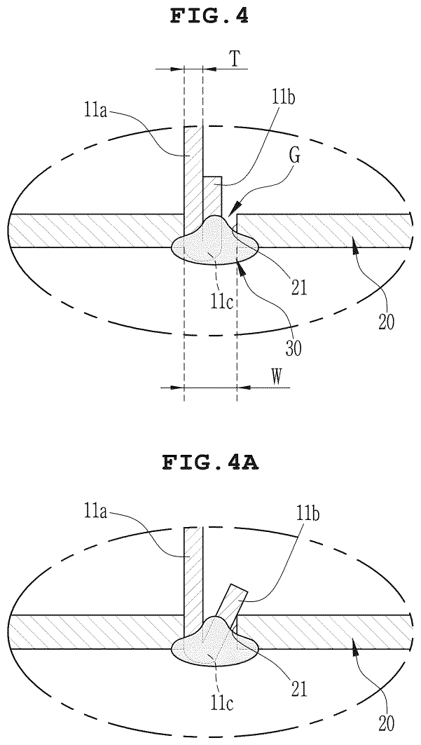

Specifically, the bending angle may be set to a range of greater than 90° and no greater than 180°. More specifically, the electrode tab 11 may be bent at a bending angle of 180° as shown in FIG. 4. In other words, the distal end-side extension portion 11b may be bent at a bending angle of 180° about the bending portion 11c to be disposed in face-to-face contact with the extension portion 11a. As a result, as the distal end-side extension portion 11b is bent at 180° to overlap with the extension portion 11a in a thickness direction, the extension portion 11a and the distal end-side extension portion 11b may be positioned on the same plane.

In addition, electrode tabs 11 may protrude in opposite directions from both sides, respectively, of the battery cell 10 as illustrated, or, unlike the illustration, may protrude side by side in the same direction from one side of the battery cell 10.

The busbar 20 may be formed in a plate shape to cover one sides of the plurality of battery cells 10, and may be made of an electrically conductive material which is defined to be electrically connected to the electrode tabs 11 of the battery cells 10 and stably transfer a high voltage to the outside without loss.

In particular, the busbar 20 is formed with a plurality of slits 21 in the inner regions thereof. The slit 21 is formed in a size and shape capable of accommodating the bent portion of the electrode tab 11, so that the bent portion of the electrode tab 11 may be inserted into the slit 21. The bent portion of the electrode tab 11 may protrude out of the outer surface of the busbar 20 by passing through the slit 21 in the thickness direction of the busbar 20.

Moreover, in the present disclosure, in order to ensure that the bent portion of the electrode tab 11 may be disposed by being smoothly inserted into the slit 21, a width W of the slit 21 is set to be at least two times the thickness T of the electrode tab 11. Of course, in the present disclosure, the size of the width W of the slit 21 may be set to provide a gap G between the bent portion of the electrode tab 11 and the slit 21. A portion of the bent portion of the electrode tab 11 is melted by laser irradiation, and the melted portion may be introduced into the gap G between the electrode tab 11 and the slit 21 to become a portion of a welded portion 30.

In the present disclosure, a portion of the electrode tab 11 which passes through the slit 21 of the busbar 20, specifically, the bent portion of the electrode tab 11, is heated and melted by laser to form the welded portion 30. As a result, the electrode tab 11 inserted into the slit 21 and the busbar 20 may be joined to each other by the welded portion 30. By this fact, the battery module according to the present disclosure may supply high voltage power by connecting the plurality of battery cells 10 together in series and/or in parallel.

Alternatively, as the case may be, the electrode tab 11 may be bent at an obtuse bending angle greater than 90° and smaller than 180° as shown in FIG. 4A. For example, the distal end-side extension portion 11b may be bent at a bending angle of 135° about the bending portion 11c to be disposed opposite the extension portion 11a. Due to this fact, the electrode tab 11 is formed in a sharp V shape, so that the extension portion 11a and the distal end-side extension portion 11b are not positioned on the same plane.

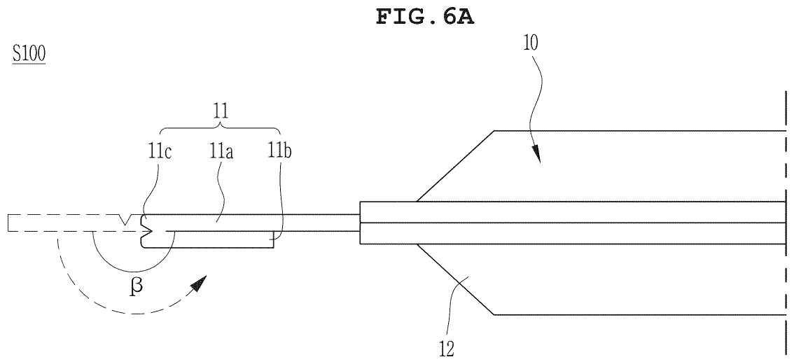

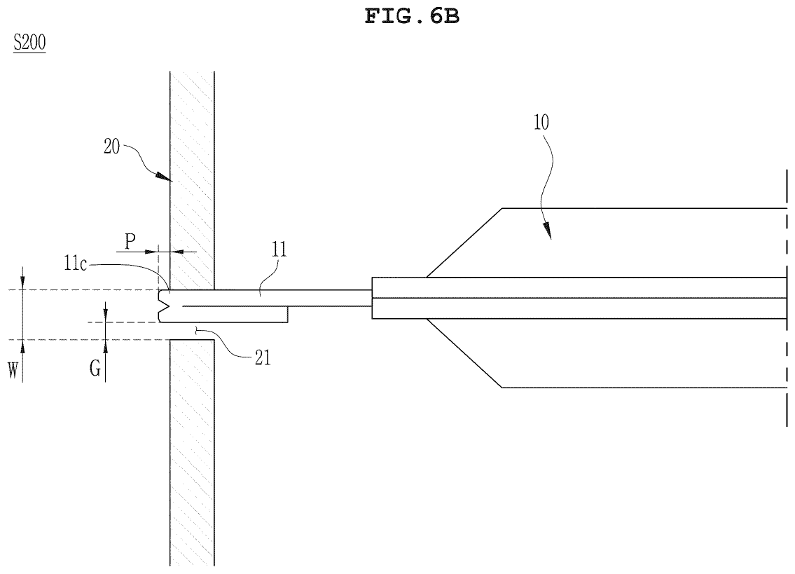

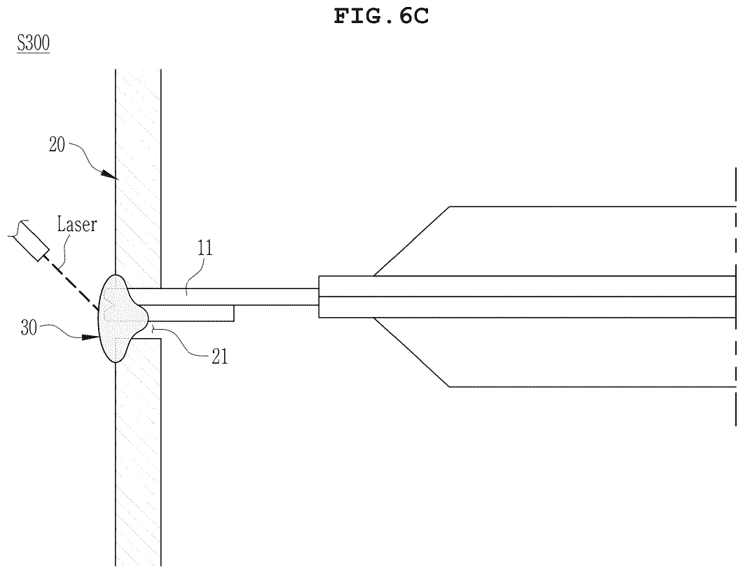

As the electrode tab 11 is bent into the sharp V shape, the electrode tab 11 may be elastically supported in the slit 21 of the busbar 20. This may help to fix the position of the electrode tab 11 disposed by being inserted into the slit 21 during a welding step to be described later, and additionally, may keep a protruding length P (see FIG. 6B) of the electrode tab 11 constant. In addition, the portion of the electrode tab 11 which is melted by laser irradiation may be introduced into a space delimited by the distal end-side extension portion 11b of the electrode tab 11 and the slit 21, while being prevented from flowing toward the inner surface of the busbar 20 facing the battery cell 10.

FIGS. 5A to 5C are views schematically illustrating a battery cell to which an electrode tab of another embodiment is applied, and disclose an electrode tab 11 having a structure which may be bent from a flat state to have a predetermined bending angle.

As shown, the electrode tab 11 may extend from the electrode of the electrode assembly accommodated in the pouch case 12, and may protrude out of the pouch case 12. As shown in FIG. 5A, the electrode tab 11 is formed into a flat shape composed of the extension portion 11a, the distal end-side extension portion 11b and the bending portion 11c which integrally connects the extension portion 11a and the distal end-side extension portion 11b to each other.

The electrode tab 11 is connected to the busbar 20 by being inserted into the slit 21 of the busbar 20. The electrode tab 11 is inserted into the slit 21 so that the bending portion 11c of the electrode tab 11 protrudes to the front of the busbar 20. To this end, the distal end-side extension portion 11b of the electrode tab 11 is bent rearward toward the battery cell 10 at the bending portion 11c.

Optionally, the electrode tab 11 may be formed with a bending groove 11d on one surface of the bending portion 11c. As shown, the bending groove 11d is recessed in a V shape or an arch shape by a predetermined depth from the one surface toward the other surface of the bending portion 11c. Specifically, in the electrode tab 11, the bending groove 11d may be disposed outside the bent portion.

The thickness of the bending portion 11c is set to be thinner than the thickness of other portions (e.g., the extension portion 11a and the distal end-side extension portion 11b) adjacent to the bending portion 11c due to the presence of the bending groove 11d. Due to this fact, the flexural strength (bending strength) of the bending portion 11c is lower than the flexural strength of the extension portion 11a and the distal end-side extension portion 11b adjacent to the bending portion 11c. As a result, since the electrode tab 11 may easily induce bending of the bending portion 11c compared to the extension portion 11a and/or the distal end-side extension portion 11b, it is possible to not only prevent the occurrence of a crack in the electrode tab 11 during bending but also bend the distal end-side extension portion 11b at the predetermined bending angle β.

Specifically, in the electrode tab 11, the bending angle β may be set to a range of greater than 90° and no greater than 180°.

FIG. 5B illustrates the electrode tab 11 bent at a bending angle β of 180° so that the extension portion 11a and the distal end-side extension portion 11b may be disposed to overlap with each other.

Unlike this, FIG. 5C illustrates the electrode tab 11 in which the bent portion of the electrode tab 11 is bent into a V shape. The distal end-side extension portion 11b is bent toward the battery cell 10 at an obtuse bending angle β about the bending portion 11c.

As described above, the present disclosure is characterized in that the electrode tab 11 having a bending structure is welded by being fitted into the slit 21 of the busbar 20. Hereinafter, an assembly method of contact-fixing the electrode tab 11 and the busbar 20 by means of laser welding in such a way to be electrically connected with each other will be described.

The present disclosure includes a step S100 of bending the electrode tab 11 of the battery cell 10. As shown in FIG. 6A, in the electrode tab 11, the distal end-side extension portion 11b is bent toward the proximal end of the electrode tab 11 at the bending portion 11c. The distal end-side extension portion 11b may be bent at the predetermined bending angle β with respect to the bending portion 11c. The bending angle β may be set to a range of greater than 90° and no greater than 180°.

FIG. 6A illustrates, as an example, the electrode tab 11 which is bent at the bending angle β of 180°. As is well known to those skilled in the art, in the process of bending the electrode tab 11, as wrinkles are formed inside the bent portion of the electrode tab 11, the thickness of the bent portion becomes larger than two times the thickness T of the electrode tab 11. In this consideration, a step of flattening the bent portion of the electrode tab 11 by applying press molding to the bent portion of the electrode tab 11 may be added.

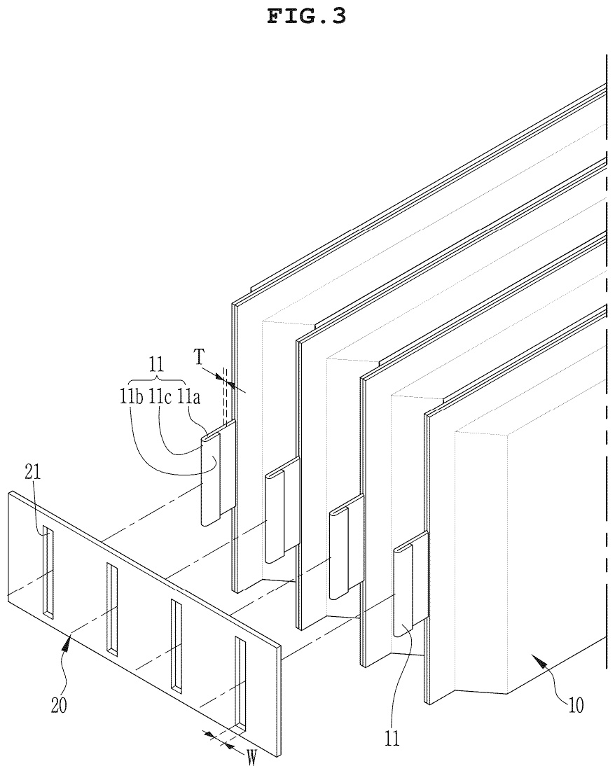

In this way, since the bent portion of the electrode tab 11 has a predetermined bending thickness and is smoothly inserted without bending deformation of the electrode tab 11 in the process of being inserted into the slit 21 of the busbar 20, it is possible to anticipate improved assemblability. In addition, since the width W (see FIG. 3) of the slit 21 of the busbar 20 may be set to provide a wide structure in consideration of the bending thickness of the electrode tab 11, workability of the busbar 20 may be improved.

As shown, in the present disclosure, the electrode tab 11 may be bent by bending the distal end-side extension portion 11b at a bending angle β of 180° about the bending portion 11c to overlap with the extension portion 11a. Due to this fact, as shown in FIG. 6B, it is possible to realize a good adhesion state between the electrode tab 11 and the inner surface of the slit 21 of the busbar 20.

Of course, in the present disclosure, the electrode tab 11 may be bent into a sharp V shape by bending the distal end-side extension portion 11b at an obtuse bending angle β about the bending portion 11c (see FIG. 4A or FIG. 5c).

Optionally, in the present disclosure, the bending groove 11d (see FIG. 5A) may be formed on one surface of the bending portion 11c. The bending groove 11d may be disposed outside the bent portion of the electrode tab 11 to easily induce the bending of the electrode tab 11.

Referring to FIG. 6B, the present disclosure includes a step S200 of inserting and disposing the bent portion of the electrode tab 11 into the slit 21 of the busbar 20.

In the inserting and disposing step S200 of the present disclosure, the bent portion of the electrode tab 11 is inserted through the slit 21 so that the bent portion of the electrode tab 11 protrudes in a direction perpendicular to the outer surface, that is, the front, of the busbar 20.

As shown, the electrode tab 11 may be bent at a bending angle of 180° to provide a predetermined bending thickness (two times the thickness T of the electrode tab 11), so that the electrode tab 11 is smoothly inserted into the slit 21 without bending deformation of the electrode tab 11 and the gap between the electrode tab 11 and the slit 21 may be narrowed.

In addition, the electrode tab 11 may be elastically supported in the slit 21 by being bent at an obtuse bending angle β to have a sharp V shape as shown in FIG. 4A. This may help to fix the position of the electrode tab 11 disposed by being inserted into the slit 21 during a welding step to be described later, and additionally, may keep the protruding length P of the electrode tab 11 constant. In addition, the portion of the electrode tab 11 melted by laser irradiation may be controlled to be introduced into only a space delimited by the distal end-side extension portion 11b of the electrode tab 11 and the slit 21.

In addition, in the present disclosure, the size of the width W of the slit 21 is set so that the bent portion of the electrode tab 11 bent at a bending angle of greater than 90° and no greater than 180° may be smoothly inserted into the slit 21. Specifically, the width W of the slit 21 is set to provide the gap G between the electrode tab 11 and the inner surface of the slit 21 in a state in which the bent portion of the electrode tab 11 is accommodated in the slit 21. The gap G has a size smaller than or equal to the thickness T of the electrode tab 11. That is to say, in the present disclosure, the width W of the slit 21 may be set in a range of 2T≤W≤3T. The thickness of the electrode tab 11 is expressed as T. In more detail, the gap G has a size equal or smaller than 0.3 mm as the minimum thickness of the electrode tab 11.

In addition, in the present disclosure, the bent portion of the electrode tab 11 on the outer surface of the busbar 20 may protrude from the outer surface of the busbar 20 by the predetermined protruding length P. Here, 0.3 mm≤protruding length P of the electrode tab≤2.0 mm is satisfied. As is known to those skilled in the art, the protruding bent portion of the electrode tab 11 is melted by laser irradiation to be introduced between the electrode tab 11 and the slit 21 through the aforementioned gap G.

When the protruding length P of the electrode tab 11 is smaller than 0.3 mm, the melted amount of the electrode tab 11 may not be sufficiently secured, thereby decreasing the welding efficiency between the electrode tab 11 and the busbar 20. Unlike this, when the protruding length P of the electrode tab 11 exceeds 2.0 mm, the protruding bent portion of the electrode tab 11 should be melted with laser of a relatively high output to be sufficiently melted, and in this regard, problems such as excessive melting amount, decrease in viscosity of melted metal and back bead may be caused. The back bead as a phenomenon that may occur due to over-welding means a phenomenon in which a welded portion is unnecessarily formed on a surface (i.e., the inner surface of the busbar 20) opposite to a surface on which laser welding is performed.

The present disclosure includes a step S300 of forming the welded portion 30 as shown in FIG. 6C. In detail, in the present disclosure, the welded portion 30 may be formed by performing laser welding on the electrode tab 11 inserted into the slit 21 and the busbar 20, whereby (the bent portion of) the electrode tab 11 and the busbar 20 may be joined to each other.

In the present disclosure, the welded portion 30 is formed by irradiating laser on a welding portion, melting a portion of the protruding bent portion of the electrode tab 11 with the energy of laser and then solidifying the melted portion. As described above, in the electrode tab 11, a portion of the bent portion is melted by laser irradiation, and the melted portion is interposed between the electrode tab 11 and the slit 21 in the gap G to form the welded portion 30, whereby the electrode tab 11 and the busbar 20 may be joined to each other. As is well known to those skilled in the art, a portion of the busbar 20 adjacent to the slit 21 may also be melted by laser irradiation.

Although the embodiment of the present disclosure has been described for illustrative purposes, it will be appreciated that the present disclosure is not limited thereto. Those skilled in the art will appreciate that various modifications, additions and substitutions are possible without departing from the scope and spirit of the present disclosure.

Accordingly, any and all modifications, variations or equivalent arrangements should be considered to be within the scope of the present disclosure, and the detailed scope of the present disclosure will be defined by the accompanying claims.

What is claimed is:

1. A battery module comprising:
a plurality of battery cells each including an electrode tab; and
a busbar having a plurality of slits, and electrically connecting the plurality of battery cells to each other,
wherein the electrode tab is bent and is inserted into the slit, and
wherein a bent portion of the electrode tab inserted into the slit and the busbar are joined to each other by a welded portion.

2. The battery module of claim 1, wherein the bent portion of the electrode tab is inserted to protrude by passing through the slit.

3. The battery module of claim 1, wherein the electrode tab is bent at a bending angle set in a range of greater than 90° and no greater than 180°.

4. The battery module of claim 1, wherein the electrode tab comprises:
an extension portion protruding outward from an electrode assembly of the battery cell;
a distal end-side extension portion bent at a predetermined bending angle with respect to an extension line of the extension portion; and
a bending portion integrally connecting the extension portion and the distal end-side extension portion to each other.

5. The battery module of claim 1, wherein the electrode tab is formed with a bending groove on one surface of the bending portion.

6. The battery module of claim 1, wherein the welded portion is formed by laser welding.

7. A method of assembling a battery module, comprising:
bending an electrode tab of a battery cell at a predetermined bending angle;
inserting and disposing a bent portion of the electrode tab into a slit of a busbar; and
welding the bent portion of the electrode tab and the busbar to electrically connect the electrode tab and the busbar to each other,
wherein the bending angle of the electrode tab is set in a range of greater than 90° and no greater than 180°.

8. The method of claim 7, wherein the electrode tab comprises:
an extension portion protruding outward from an electrode assembly of the battery cell;
a distal end-side extension portion bent at a predetermined bending angle with respect to an extension line of the extension portion; and
a bending portion integrally connecting the extension portion and the distal end-side extension portion to each other.

9. The method of claim 7, wherein, in the inserting and disposing of the bent portion of the electrode tab into the slit of the busbar, the bent portion of the electrode tab is inserted to protrude by passing through the slit.

10. The method of claim 9, wherein the bent portion of the electrode tab protrudes by a predetermined protruding length P from an outer surface of the busbar, where 0.3 mm≤P≤2.0 mm.

11. The method of claim 7, wherein, in the inserting and disposing of the bent portion of the electrode tab into the slit of the busbar, a gap is provided between the bent portion of the electrode tab and the slit of the busbar.
